(19) United States
(12) Patent Application Publication
(10) Pub. No.: US 2013/0292115 A1
(43) Pub. Date: Nov. 7, 2013

(54) STEAM GENERATOR BLOWDOWN MANAGEMENT

(71) Applicants: Kris M. Bansal, Houston, TX (US); Ramesh R. Sharma, Houston, TX (US)

(72) Inventors: Kris M. Bansal, Houston, TX (US); Ramesh R. Sharma, Houston, TX (US)

(73) Assignee: ConocoPhillips Company, Houston, TX (US)

(21) Appl. No.: 13/464,581

(22) Filed: May 4, 2012

(51) Int. Cl. E21B 43/24; B01D 43/00; C02F 9/02; C02F 101/30

(52) U.S. Cl. 166/272.3; 210/702; 210/737; 210/710; 494/37; 166/90.1

(57) ABSTRACT

Systems and methods relate to treating wastewater, such as blowdown from steam generators used in oil sands production. The systems rely on precipitation by acidification of the wastewater along with passing the wastewater at a pressure of at least 138 kilopascals through a multiphase centrifuge to remove at least partially organic and/or silica solids. A resulting treated aqueous stream may meet thresholds desired for injection into a disposal well.

### CROSS-REFERENCE TO RELATED APPLICATIONS

None.

### STATEMENT REGARDING FEDERALLY SPONSORED RESEARCH OR DEVELOPMENT

None.

### FIELD OF THE INVENTION

Embodiments of the invention relate to treating of blowdown (wastewater) generated during steam production for hydrocarbon recovery.

### BACKGROUND OF THE INVENTION

Several techniques utilized to recover hydrocarbons from oil sands rely on generated steam to heat and lower viscosity of the hydrocarbons when the steam is injected into the oil sands. One common approach for this type of recovery includes steam assisted gravity drainage (SAGD). The hydrocarbons once heated become mobile enough for production along with the condensed steam.

Deoiled produced water along with blowdown from steam generators, such as drum boilers or once through steam generators (OTSG), requires treatment for producing a process stream with desired quality for steam generators and a wastewater stream for disposal. The wastewater contains inorganics (including silica), dispersed and soluble organics and often has a pH between 9.5 and 13. Environmental restrictions along with problems from plugging and fouling of injection pipelines and disposal wells necessitate treatment of the wastewater.

Prior treatment processes for the wastewater fail to provide a cost effective option with desired results. Operational problems with these processes include organics in the wastewater tending to plug a filter press used for primary mechanical dewatering of solids generated in the processes. Chemical treatment costs in other processes limit feasible application at amounts needed for these applications.

Therefore, a need exists for methods and systems to treat wastewater generated during steam production for hydrocarbon recovery.

### BRIEF SUMMARY OF THE DISCLOSURE

In one embodiment, a method of treating wastewater includes adding an acid to a blowdown stream to reduce pH from above 9 to below 9. This acidification provides a suspension by precipitating a particulate formed from at least one of organic solids and inorganics coated with organic materials. Centrifuging the suspension at a pressure of at least 138 kilopascals concentrates the particulates in a solid phase removal stream relative to a separated treated aqueous stream.

According to one embodiment, a method of treating wastewater includes producing a blowdown stream formed of a suspension with precipitate. The precipitate includes silica. The method further includes passing the suspension that contains dispersed oil and is at a pressure of at least 138 kilopascals through a centrifuge to remove at least 99% by weight of the precipitate from resulting separated treated aqueous and liquid organic streams.

For one embodiment, a system for treating wastewater includes a blowdown stream chiller configured to lower temperature of a blowdown stream, a first injector coupled to treat the blowdown stream with hydrogen peroxide for removal of hydrogen sulfide, a second injector coupled to add an acid to the blowdown stream for pH reduction and a reaction tank in fluid communication with the blowdown stream mixed with the acid. A centrifuge couples to an output of the reaction tank and is configured to operate at a pressure above 138 kilopascals for providing a solid phase removal stream with concentrated inorganic and organic solid particulates relative to separated treated aqueous and liquid organic streams. In addition, the system includes a dewatering assembly coupled to the solid phase removal stream output from the centrifuge to provide dewatered solids for landfill disposal, a filter coupled to the treated aqueous stream output from the centrifuge to remove residual particulates, a third injector coupled to add caustic to the treated aqueous stream output from the centrifuge to increase pH (if necessary), and a disposal well in fluid communication with output from the centrifuge downstream of the filter and third injector for injection of the treated aqueous stream.

### BRIEF DESCRIPTION OF THE DRAWINGS

A more complete understanding of the present invention and benefits thereof may be acquired by referring to the following description taken in conjunction with the accompanying drawings.

FIG. 1 is a schematic of a system for treating wastewater by removing particulates downstream of an acid reactor, according to one embodiment of the invention.

FIG. 2 is a schematic of another system for treating wastewater by removing particulates both upstream and downstream of an acid reactor, according to one embodiment of the invention.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated.

Embodiments of the invention relate to systems and methods of treating wastewater, such as blowdown from steam generation equipment (e.g., evaporators and drum boilers, evaporators and once through steam generators (OTSG), or OTSG and OTSG) used in SAGD or other oil sands production. The systems rely on precipitation by acidification of the wastewater along with passing the wastewater at a pressure of at least 138 kilopascals through a multiphase centrifuge to remove at least partially organic and/or silica solids. A resulting treated aqueous stream may meet thresholds desired for injection into a disposal well.

Examples of the steam generators include drum boilers and OTSG. In some embodiments, the blowdown from the steam generator combines with deoiled produced water and passes through an evaporator, such as a high pH or sorption slurry evaporator. The distillate from the evaporator recycles to the steam generator with the blowdown from the evaporator providing the wastewater for treatment. More recent techniques referred to as a reboiler utilize multiple OTSG connected together for eliminating the evaporator and producing the blowdown for treatment directly from a final one of the OTSG.

For some embodiments, the blowdown from the evaporator associated with the drum boilers contains 200-7,000 milligrams per liter (mg/L) of silica, soluble organics expressed as 1,000-15,000 mg/L total organic carbon (TOC), 10-2,000 parts per million (ppm) dispersed organics and 20,000-150,000 mg/L total dissolved solids (TDS) and pH above 9 or between 10 and 13. The blowdown in some embodiments where associated with the OTSG contains similar constituent concentrations but with dissolved silica between 150-2000 mg/L and pH between 11.5 and 13. Temperatures of such blowdown streams exceed 100° C.

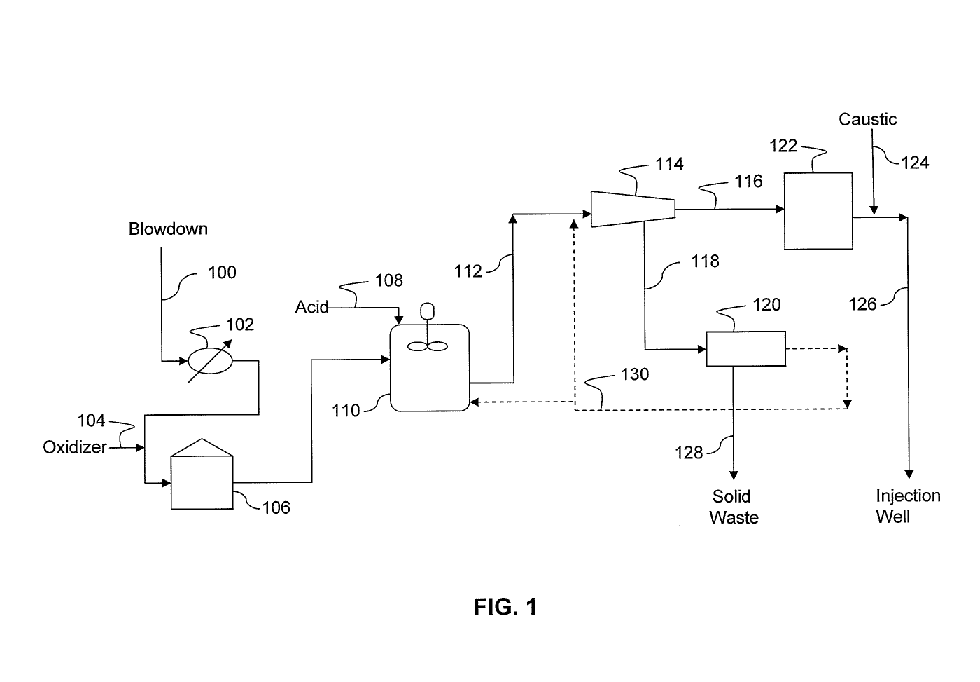

FIG. 1 shows a wastewater treatment system that includes a chiller 102, a brine feed tank 106, a reaction tank 110, a multiphase high pressure centrifuge 114, a dewatering assembly 120 and a polishing filter 122. In operation, the chiller 102 cools blowdown 100 to a temperature sufficient to avoid flash vaporization during processing, such as below 100° C. or to between 65° C. and 80° C. Examples of the chiller 102 include heat exchangers or flashing units.

A first injector 104 then supplies an oxidizer, such as hydrogen peroxide, to the blowdown 100 for removal of hydrogen sulfide. Avoiding possible evolution of the hydrogen sulfide helps mitigate corrosion and limits potential for hydrogen sulfide release creating a safety hazard. The brine feed tank 106 provides temporary storage and feed control of the blowdown 100 to the reaction tank 110.

A second injector 108 introduces an acid, such as hydrochloric acid, to mix with the blowdown 100 in the reaction tank 110. In some embodiments, the acid reduces pH of the blowdown 100 to below 9.0 or between 6.0 and 8.9. Reaction time of the blowdown 100 and the acid in the reaction tank 110 determines reduction level of dissolved silica and may range from 15 to 90 minutes. For some embodiments, this acidification alone and without relying on any seeding with solids enables precipitation of the dissolved silica for reducing the dissolved silica concentration 30-90% or to below 300 mg/L.

Soluble organics in the blowdown 100 also precipitate due to the acidification. Depending on pH selected, 5-30% of the soluble organics in the blowdown 100 may precipitate and may form a coating on the silica that precipitates. Resulting precipitated solids define oily, organic laden and deformable masses. Smaller size and relative softness of these solids compared to particulates generated by solid precipitants limit ability to separate liquid and solid phases by conventional centrifuging or hydrocyclones. The organics that form at least part of the solids further limit ability to utilize filtering since the particles tend to stick together agglomerating and clogging filter media.

A suspension 112 with the precipitated solids thus outputs from the reaction tank 110 and passes to the pressure centrifuge 114. The pressure centrifuge 114 operates at a pressure above atmospheric pressure or at least 138 kilopascals. The pressure at which the suspension 112 passes through the pressure centrifuge 114 ensures an interface is maintained between at least the solid and liquid phases and can be tuned to solid compositions encountered.

In some embodiments, the pressure centrifuge 114 separates oil, water, gas and solid phases into different streams. The centrifuging in some embodiments results in 99% by weight of the precipitates in the suspension 112 being isolated in a solid phase removal stream 118. Solids content in the solid phase removal stream 118 may range from 1% to 10% by weight.

For some embodiments, the centrifuging occurs with the suspension 112 at a temperature between 65° C. and 80° C. The pressure centrifuge 114 may also provide a continuous flow of a treated aqueous stream 116 uninterrupted by withdrawal of the solid phase removal stream 118 such that the suspension 112 remains isolated from exposure to oxygen since the pressure centrifuge 114 does not require opening to atmosphere for withdrawal of the solid phase removal stream 118. Limiting oxygen ingress facilitates in reducing corrosion potential.

The solid phase removal stream 118 passes to the dewatering assembly 120, which may include a decanter centrifuge or a filter press. The dewatering assembly 120 generates a solid waste 128 that is at least 30%, or 30% to 40%, by weight solids content for landfill disposal. A liquid recycle stream 130 from the dewatering assembly 120 may feed back to the reaction tank 110 and/or the pressure centrifuge 114.

The treated aqueous stream 116 output from the pressure centrifuge 114 may undergo any further processing needed to meet desired quality for injection well fluid 126, which is injected into a disposal well. For example, the treated aqueous stream 116 may pass through the polishing filter 122 to remove any residual particulates. Further, a third injector 124 may supply a caustic to the treated aqueous stream 116 for final pH adjustment, if necessary. The caustic may raise the pH to between 8.5 and 9.0 or between 8.8 and 8.9 to limit risk of subsequent solid precipitation in pipelines and the disposal well.

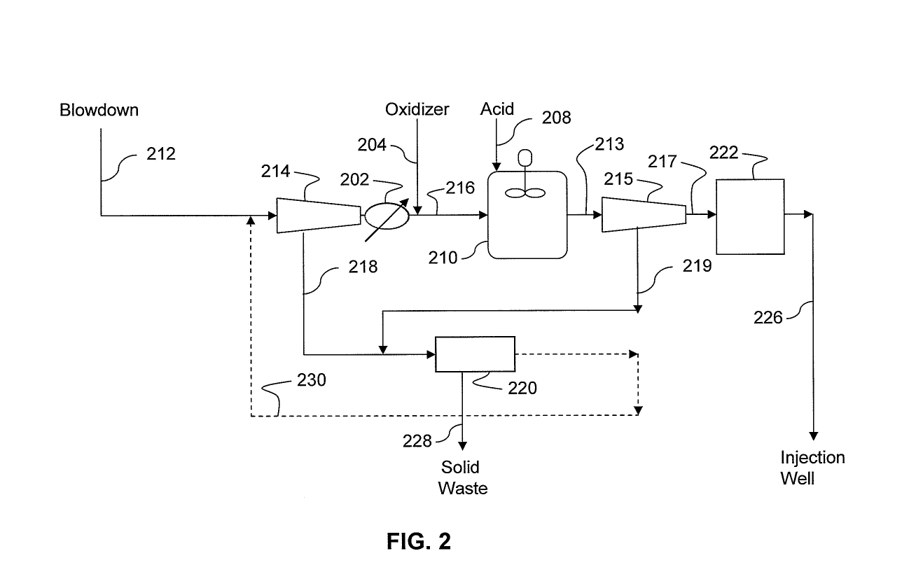

FIG. 2 illustrates another wastewater treatment system, which may receive blowdown 212 input from a sorption slurry evaporator and, similar to the system in FIG. 1, includes a pressure centrifuge 214, a chiller 202, a reaction tank 210, a separator 215, a dewatering assembly 220 and a polishing filter 222. The sorption slurry evaporator may intake the blowdown from the steam generator combined with the deoiled produced water along with solids, such as magnesium oxide, added to precipitate silica. For some embodiments, the blowdown 212 contains 4-6% solids, 30-1000 ppm dissolved silica, pH between 9.5 and 12 and otherwise similar constituent concentrations as other blowdown streams described herein.

The solids in the blowdown 212 include the precipitated magnesium hydroxide silica in a first suspension that presents many aforementioned separation challenges due to composition of the blowdown 212. The blowdown 212 therefore passes through the pressure centrifuge 214 for primary solid and liquid phase separation of the blowdown 212 into an initial treated aqueous stream 216 and a first solid phase removal stream 218, which has the particulates concentrated relative to the initial treated aqueous stream 216. The pressure centrifuge 214 shown in FIG. 2 operates analogous to the pressure centrifuge 114 shown in FIG. 1 and described herein such that performance details are not repeated for succinctness.

The blowdown 212 may however pass through the pressure centrifuge 214 at a temperature above 100° C. depending on location of the chiller 202. The chiller 202 may cool the initial treated aqueous stream 216 output from the pressure centrifuge 214 prior to input into the reaction tank 210 in order to limit fouling in the chiller 202 since the solids are already removed by the pressure centrifuge 214. In other embodiments, the chiller 202 cools the blowdown 212 prior to passing through the pressure centrifuge 214.

A first injector 204 delivers hydrogen peroxide to the initial treated aqueous stream 216 for hydrogen sulfide removal. A second injector 208 adds acid to the initial treated aqueous stream 216. The acid and the initial treated aqueous stream 216 mix in the reaction tank 210 to provide a resulting mixture with a pH between 6.0 and 8.9. This acidification causes 5% to 30% of organics in the mixture to precipitate along with some additional inorganic solids to provide a second suspension 213.

The second suspension 213 exits the reaction tank 210 and passes through a separator 215. For some embodiments, a filter press or another pressure centrifuge like others set forth herein provides the separator 215. A final treated aqueous stream 217 output from the separator 215 may undergo further processing, such as passing through the polishing filter 222 to create an injection well fluid 126 for sending to a disposal well.

A second solid phase removal stream 219 output from the separator passes to the dewatering assembly 220 and may be combined with the first solid phase removal stream 219 from the pressure centrifuge 214. The dewatering assembly 220 may include a decanter centrifuge or a filter press. The dewatering assembly 220 generates a solid waste 228 that is at least 30%, or 30% to 40%, by weight solids content for landfill disposal. A liquid recycle stream 230 from the dewatering assembly 220 may feed back to blend with the blowdown 212 input into the pressure centrifuge 214.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims, while the description, abstract and drawings are not to be used to limit the scope of the invention. Each and every claim below is hereby incorporated into this detailed description or specification as a additional embodiments of the present invention. The invention is specifically intended to be as broad as the claims below and their equivalents.

1. A method of treating wastewater, comprising:
adding an acid to a blowdown stream to reduce pH from above 9 to below 9, wherein acidification provides a suspension by precipitating a particulate formed from at least one of organic solids and inorganics coated with organic material; and
centrifuging the suspension that contains dispersed oil and is at a pressure of at least 138 kilopascals to concentrate the particulates in a solid phase removal stream relative to separated treated aqueous and liquid organic streams.

2. The method according to claim 1, wherein the blowdown stream is recovered from a sorption slurry evaporator and further comprising centrifuging the blowdown stream at a pressure of at least 138 kilopascals to remove a solids waste stream concentrated with a magnesium hydroxide silica relative to a remainder of the blowdown stream in which the acid is added.

3. The method according to claim 1, further comprising centrifuging the blowdown stream at a pressure of at least 138 kilopascals and a temperature above 100° C. to separate a solids waste stream from a remainder of the blowdown stream, which is cooled to below 100° C. and the acid is added.

4. The method according to claim 1, wherein the acidification precipitates the particulates consisting of silica coated with organic material.

5. The method according to claim 1, wherein the precipitating occurs with the acidification to produce the particulates that are at least one of softer and smaller than if generated by solid precipitants.

6. The method according to claim 1, wherein the centrifuging results in at least 99% by weight of the precipitates in the suspension being in the solid phase removal stream.

7. The method according to claim 1, wherein the blowdown stream is from steam generation equipment of a steam assisted gravity drainage (SAGD) operation.

8. The method according to claim 1, wherein the centrifuging provides a continuous flow of the treated aqueous stream uninterrupted by withdrawal of the solid phase removal stream.

9. The method according to claim 1, wherein the centrifuging occurs with the suspension isolated from exposure to oxygen.

10. The method according to claim 1, wherein the centrifuging occurs with the suspension at a temperature between 65° C. and 80° C.

11. The method according to claim 1, further comprising dewatering the solid phase removal stream with at least one of a filter press and a decanter centrifuge to provide at least 30% by weight solids content for landfill disposal.

12. The method according to claim 1, further comprising:
cooling the blowdown stream from above 100° C. to below 100° C.;
treating the blowdown stream with hydrogen peroxide to remove hydrogen sulfide;
reacting the acid mixed with the blowdown stream for at least 15 minutes to provide the particulates in the suspension with a pH below 8.5;
dewatering the solid phase removal stream to provide at least 30% by weight solids content for landfill disposal;
filtering the treated aqueous stream to remove residual particulates;
adding caustic to the treated aqueous stream to increase pH from below 8.5 to between 8.5 and 9.0; and
injecting into a disposal well the treated aqueous stream following the filtering and adding of the caustic.

13. The method according to claim 1, further comprising injecting the treated aqueous stream into a disposal well.

14. A method of treating wastewater, comprising:
producing a blowdown stream formed of a suspension with precipitate that includes silica; and
passing the suspension that contains dispersed oil and is at a pressure of at least 138 kilopascals through a centrifuge to remove at least 99% by weight of the precipitate from resulting separated treated aqueous and liquid organic streams.

15. The method according to claim 14, wherein the producing of the blowdown stream includes reducing pH of the blowdown stream and the precipitate consists of the silica coated with organic material.

16. The method according to claim 14, further comprising reducing pH of the treated aqueous stream before additional centrifuging at a pressure of at least 138 kilopascals to remove a solids waste stream concentrated with organic solids relative to a remainder of the treated aqueous stream.

17. The method according to claim 14, wherein the passing of the suspension through the centrifuge is at a temperature above 100° C.

18. The method according to claim 14, wherein the blowdown stream is from a sorption slurry evaporator of a steam assisted gravity drainage (SAGD) operation.

19. The method according to claim 14, further comprising:
reducing pH of the treated aqueous stream before additional centrifuging at a pressure of at least 138 kilopascals to remove a solids waste stream concentrated with organic solids relative to a remainder of the treated aqueous stream; and
dewatering the solid waste stream combined with the precipitate removed from the treated aqueous stream.

20. A system for treating wastewater, comprising:
a blowdown stream chiller configured to lower temperature of a blowdown stream;
a first injector coupled to treat the blowdown stream with hydrogen peroxide for removal of hydrogen sulfide;
a second injector coupled to add an acid to the blowdown stream for pH reduction;
a reaction tank in fluid communication with the blowdown stream mixed with the acid;
a centrifuge coupled to an output of the reaction tank, wherein the centrifuge is configured to operate at a pressure of at least 138 kilopascals for providing a solid phase removal stream with concentrated inorganic and organic solid particulates relative to separated treated aqueous and liquid organic streams;
a dewatering assembly coupled to the solid phase removal stream output from the centrifuge to provide dewatered solids for landfill disposal;
a filter coupled to the treated aqueous stream output from the centrifuge to remove residual particulates; and
a disposal well in fluid communication with output from the centrifuge downstream of the filter and third injector for injection of the treated aqueous stream.
